(19) United States
(12) Patent Application Publication
(10) Pub. No.: US 2019/0128403 A1
(43) Pub. Date: May 2, 2019

(54) SHIFT LEVER ASSEMBLY WITH ANGLED ACTUATOR

(71) Applicant: Dura Operating, LLC, Auburn Hills, MI (US)

(72) Inventors: Alberto Polonio Morales, West Bloomfield, MI (US); Sai Her, Warren, MI (US)

(21) Appl. No.: 15/800,511

(22) Filed: Nov. 1, 2017

(51) Int. Cl. F16H 59/02; F16H 59/10

(52) U.S. Cl. CPC F16H 59/0278; F16H 2059/0282; F16H 59/10

(57) ABSTRACT

In at least some implementations, a shift lever assembly includes a shift lever having a shaft, a retainer and a button. The button is movable from a first position to a second position, and the retainer is movable relative to the shaft. The assembly also includes an actuator having a first portion engageable with the button as the button moves from its first position to its second position and a second portion engageable with the retainer to displace the retainer.

### TECHNICAL FIELD

The present disclosure relates generally to a shift lever for a transmission shift lever assembly having an angled actuator.

### BACKGROUND

In some vehicles, a gear shift lever in a passenger compartment of the vehicle can be moved by an operator of the vehicle to shift the vehicle transmission between its park gear and other gears, such as reverse, neutral and forward drive gears. The shift lever is mechanically coupled to the transmission through a cable that transmits the shift lever movement to a transmission shift mechanism. Other vehicles use a so-called “shift-by-wire” system wherein an operator shift lever or shift control unit is not physically coupled to the transmission shift mechanism by a cable. Instead, the shift control unit is electrically coupled to a shift actuator that is arranged to shift the transmission upon receipt of a signal from the shift control unit that a transmission gear shift is desired by the operator.

A lockout device may be incorporated in the shift lever to hold the shift lever in one or more of its positions. The device may be actuated by a button on the shift lever to permit the shift lever to be moved from one position to another, such as to permit the shift lever to be moved to shift the transmission from park, or to permit the transmission to be shifted into reverse gear.

### SUMMARY

In at least some implementations, a shift lever assembly includes a shift lever having a shaft, a retainer and a button. The button is movable from a first position to a second position, and the retainer is movable relative to the shaft. The assembly also includes an actuator having a first portion engageable with the button as the button moves from its first position to its second position and a second portion engageable with the retainer to displace the retainer.

In at least some implementations, the first portion of the actuator is a separate component from the second portion of the actuator. The first portion of the actuator may be displaced by the button in a first direction, and the second portion of the actuator may be displaced by the first portion in a second direction that is different than the first direction. Further, the retainer may be displaced by the second portion in a direction that is different than the direction of movement of the second portion. The first portion may include a driving surface and the second portion may include a cam surface with the cam surface inclined relative to the path of movement of the first portion. The first portion may include a cam surface engageable by the button when the button moves from the first position to the second position.

In at least some implementations, a biasing member may provide a force on the retainer that opposes displacement of the retainer by the actuator. The same or another biasing member may provide a force on the actuator that opposes displacement of the actuator by the button.

In at least some implementations, the shift lever includes a knob coupled to the shaft, the button and actuator are carried by the knob and the knob includes a structure having a portion located along a line between the button and the retainer preventing direct, linear actuation of the retainer by the button. The structure may define part of an opening through the knob or a cavity within the knob.

In at least some implementations, a shift lever assembly includes a shift lever having a shaft, a knob, a retainer and a button, and a multi-part actuator. The knob is coupled to the shaft, the button is carried by the knob and movable from a first position to a second position, and the retainer is movable relative to the shaft. The multi-part actuator has a first portion and a second portion, the first portion is engageable with the button as the button moves from its first position to its second position to move the first portion along a first path, and the second portion is movable in response to movement of the first portion along a second path that is not parallel to the first path, and the second portion is engageable with the retainer to displace the retainer.

In at least some implementations, the first portion engages and displaces the second portion. The first portion may include a driving surface and the second portion may include a cam surface engaged by the driving surface as the first portion moves along the first path toward the second portion, and the cam surface is inclined relative to the first path.

In at least some implementations, a biasing member provides a force on the retainer that opposes displacement of the retainer by the second portion. The same or another biasing member may provide a force on the second portion that opposes displacement of the first portion and the second portion by the button.

### BRIEF DESCRIPTION OF THE DRAWINGS

The following detailed description of representative implementations and best mode will be set forth with regard to the accompanying drawings, in which:

FIG. 1 is a sectional view of a shift lever including an actuator in a first position; and

FIG. 2 is a sectional view of the shift lever showing the actuator in a second position.

### DETAILED DESCRIPTION

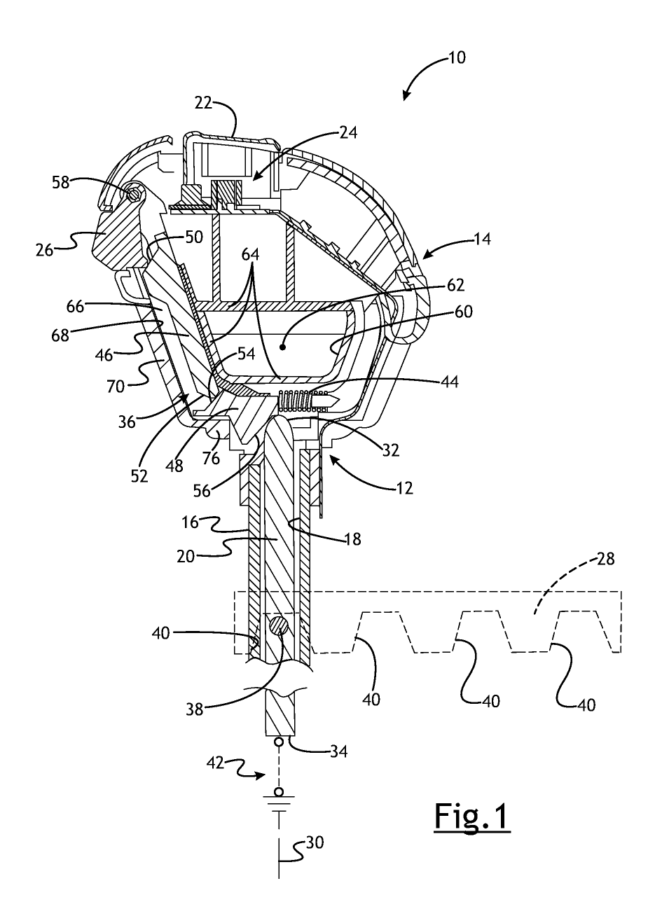

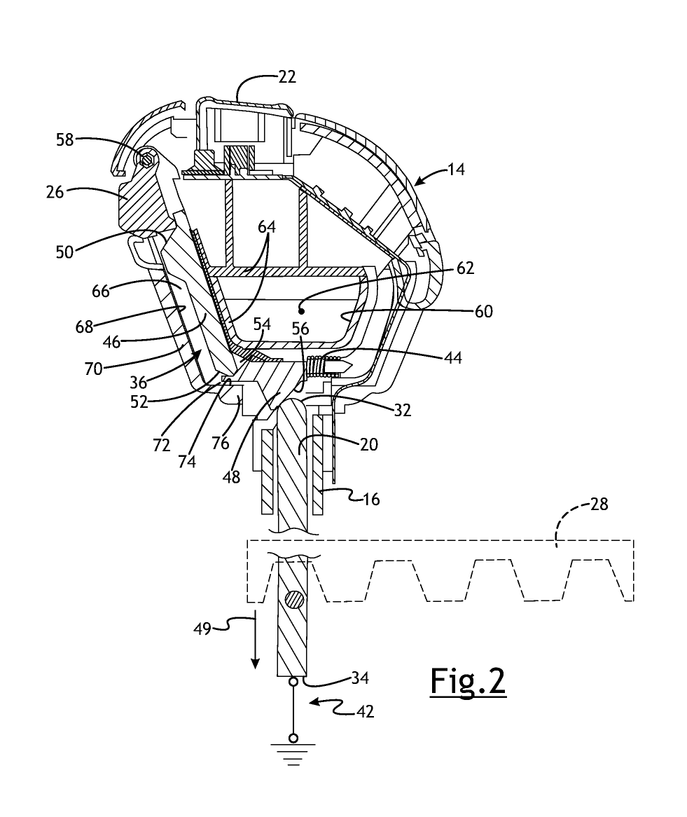

Referring in more detail to the drawings, FIGS. 1 and 2 illustrate a shift lever 10 such as may be used in a transmission shift lever assembly 12. The shift lever 10 is moved to cause a gear shift in the transmission. The shift lever 10 may be mechanically linked to a shift mechanism on the transmission, such as by a cable, to move the shift mechanism as the shift lever moves and cause a transmission gear change or shift. Or, the shift lever 10 may be electrically coupled to the shift mechanism such that movement of the shift lever causes a signal to be sent to actuate the shift mechanism in a so-called “shift-by-wire” arrangement.

The shift lever 10 may include a handle or knob 14 at one end of a shaft 16, and the shaft may be pivoted or slidably carried by a housing for movement between and among various positions. The positions correspond to various transmission gears like park, reverse, neutral and forward drive gears. At least a portion of the shaft 16 may be hollow or otherwise include a passage 18 in which a shift lever retainer 20 is received as will be set forth in more detail below. The shaft 16 may be formed from any desired material or combination of materials (e.g. metal, plastic, composite).

The shift lever knob 14 and/or shaft 16 may include or otherwise carry one or more buttons 22 operable to actuate one or more switches or sensors 24. The switches or sensors 24 may be used to actuate different vehicle driving modes (e.g. sport mode, manual shifting, economy mode, bad weather mode, etc), to control at least certain functions of a vehicle infotainment system, or other vehicle functions.

A release button 26 may also be used to release a shift lever retaining mechanism to which the shift lever 10 is coupled. The retaining mechanism may include a gate member 28 and the retainer 20 that is received within the shift lever shaft 16. In at least some implementations, the retainer may include a retaining rod 20 that is moved relative to the gate member 28 when the shift lever 10 is moved. The rod 20 may have a centerline or axis 30 that extends between first and second ends 32, 34 of the rod. The first end 32 of the rod 20 may be coupled to an angled or non-linear actuator 36 that is responsive to movement of the release button 26. The shift lever shaft 16 may be pivoted to a housing or bracket for rotational movement relative to the gate member 28 or the shaft/shift lever may be slidably moved relative to the gate member. A coupler 38 may be fixed to and may project outwardly from the rod 20, between the first and second ends 32, 34 of the rod and at a non-zero angle to the axis 30 of the rod. At least a portion of the gate member 28 includes one or more recesses 40 and may extend parallel to and be located adjacent to the path of movement of the rod 20 during movement of the shift lever 10. The coupler 38 is arranged to move along the surface of the gate member 28 and relative to the one or more recesses 40.

The coupler 38 is releasably or movably received in one or more recesses 40 of the gate member 28 to releasably maintain the shift lever 10 in one or more positions. For example, when the shift lever 10 is in the position that corresponds to the transmission being in park (as shown in FIG. 1), the coupler 38 is received in a corresponding recess 40 in the gate member 28. To move the shift lever 10 out of this position, the coupler 38 must first be removed from the corresponding recess 40 in the gate member 28. That is, attempts to move the shift lever 10 without first moving the coupler 38 out of the recess 40 are prevented by engagement of the coupler with the gate member 28.

In at least some implementations, a biasing member, such as a spring 42, acts on the rod 20 and yieldably urges the rod in a first direction. This tends to hold the coupler 38 against the gate member 28 so that the coupler is firmly received and, absent an opposing force, retained within a recess 40. As noted above, the retaining rod 20 is associated with the multi-part actuator 36, and movement of the release button 26 from a first position to a second position causes the actuator 36 to move the rod 20 against the force of the biasing member 42 to move the coupler 38 out of a recess 40. Then, the shift lever 10 can be moved relative to the gate member 28 to shift the transmission out of park and into a different gear (e.g. neutral, reverse or a forward drive gear). To reset the shift lever components and permit the coupler 38 to again be received within a recess 40 of the gate member 28, one or more biasing members 44 may yieldably bias the actuator 36 and/or the release button 26 back toward their starting positions they were in before the button was moved to the second position.

In more detail, the angled actuator 36 shown in FIGS. 1 and 2 includes at least a first portion 46 and a second portion 48. As shown by comparison of FIG. 1 to FIG. 2, the first portion 46 is responsive to at least some movement of the release button 26 so that when the button is moved from the first position (FIG. 1) to the second position (FIG. 2) the first portion is moved from a first position to a second position. The second portion 48 is responsive to at least some movement of the first portion 46 so that when the first portion is moved from the first position to the second position the second portion is moved from a first position to a second position. In turn, the rod 20 may be responsive to movement of the second portion so that when the second portion 48 is moved to the second position, the rod is displaced in the direction of arrow 49 from a first position (FIG. 1) to a second position (FIG. 2) against the force of the biasing member 42 to move the coupler 38 clear of the recess 40 (or to move the coupler far enough out of the recess that the shift lever 10 may be moved even if the coupler is not fully clear of the gate member). Accordingly, when the release button 26 is actuated to its second position, the first portion 46 and second portion 48 of the actuator 36, as well as the rod 20, are moved to their respective second positions to enable movement of the shift lever 10 relative to the gate member 28.

In at least some implementations, the first portion 46 of the actuator 36 includes a first cam surface 50 that is slidably engaged by the button 26 as the button moves to the second position. The first cam surface 50 is angled relative to the path of movement of the button 26 so that the first portion 46 of the actuator 36 is displaced further toward the second portion 48 of the actuator upon further movement of the button toward the button's second position. The first portion 46 of the actuator 36 may include a driving surface 52 spaced from the first cam surface 50, for example, at an opposite end of the first portion 46. The driving surface 52 may engage a first cam surface 54 of the second portion 48 of the actuator 36 during at least part of the movement of the first portion 46. The first cam surface 54 of the second portion 48 is angled relative to the path of movement of the driving surface 52 of the first portion 46 so that the second portion is increasingly displaced (after initial engagement by the driving surface) by further movement of the driving surface toward the cam surface 54. In at least some implementations, the second portion 48 of the actuator 36 also includes a second cam surface 56 spaced from the first cam surface 54 and arranged to engage the rod 20. The second cam surface 56 is angled relative to the path of movement of the second portion 48 to increasingly displace the rod 20 as the second portion moves toward/to its second position.

In at least some implementations, the release button 26 may be pivoted about an axis/pin 58 for rotational movement between its first and second positions. Movement of the button 26 toward its second position slidably engages the button with the first cam surface 50 of the first portion 46 and displaces the first portion away from the pivot axis 58 of the button, and generally in a first direction extending generally radially way from the pivot axis and away from the button in general. This movement of the first portion 46 slidably engages the driving surface 52 with the first cam surface 54 of the second portion 48 to displace the second portion in a second direction that is not parallel to the first direction. This movement of the second portion 48 slidably engages the second cam surface 56 of the second portion 48 with the rod 20 to displace the rod as set forth above. The direction of displacement of the rod 20 may be at an angle to, that is, not parallel to, the directions of movement of one or both of the first portion 46 and the second portion 48 of the actuator 36, if desired.

In the implementation shown, the shift lever 10 (e.g. the knob 14 and/or the shaft 16) includes a void, such as an opening 60 or a cavity. In the example shown in FIGS. 1 and 2, the opening 60 extends through the knob 14 and has a centerline 62 oriented generally perpendicularly to the axis 30 of the rod 20 and/or shift lever shaft 16. The opening 60 may be decorative or provided for some other purpose and may extend completely through the knob 14 (e.g. to receive an accessory (perhaps a mobile device or phone mount/bracket) or other component). Further, the opening 60 may instead be an internal cavity. That is, the opening 60 might be enclosed by the knob 14 rather than extending through knob. Such an opening 60 or cavity may receive electronics or other components associated with the shift lever 10, such as a sensor, selector button or knob, switch(es) or the like. The opening 60 or cavity in the knob 14 is defined by internal walls or structures 64 of the knob 14. Similar structures may be provided in the knob 14 for other purposes, and might not define any opening. In any event, in at least some implementations, at least a portion of one or more walls or other structures 64 in the knob 14 are located in a line extending between the release button 26 and the end of the rod 20 such that, a single-direction linear actuator 36 cannot be used to actuate the retaining rod. Among other things, the multi-part and multi-direction actuator set forth herein enables reliable actuation of the retaining rod 20 even with a structure located between the release button 26 and the end of the rod that is engaged by the actuator.

In at least some implementations, the first portion 46 may be received within a slot or passage 66 defined by an inner surface 68 of a first wall 70 which may be a side wall of the knob 14 (e.g. a wall at the periphery of the knob) and may be moved in a direction that is parallel to the side wall 70 or at least the inner surface thereof. The second portion 48 may be received within an adjoining passage 72 (FIG. 2) defined at least in part by an inner surface 74 of a second wall 76 which may be a bottom or base wall of the knob 14 (which may also be at the periphery of the knob) and may be moved in a direction that is parallel to the base wall or at least the inner surface thereof. The passages 66, 72 and the first portion 46 and second portion 48 of the actuator 36 may thus be positioned adjacent to the periphery of the knob 14 and spaced from a center or interior of the knob 14.

In the implementation shown, the second biasing member 44 may act on the second portion 48 of the actuator 36 to bias the second portion toward its first position, the second portion then drives the first portion 46 toward its first position and the first portion in turn drives the button 26 back toward/to its first position. Instead, the biasing member 42 that biases the rod 20 may cause the rod to displace the second portion 48 toward the first portion 46 and cause the first portion to move the button 26 back to its first position, and hence, only one biasing member 44 may be needed, in at least some implementations. The second biasing member may provide more reliable return of the components to their first positions (e.g. less frictional losses than if relying solely on the spring 42 biasing the rod 20), if desired.

In at least some implementations, a certain amount of linear displacement of the button 26 (e.g. the lateral component of its movement toward the first portion 46) causes an increased linear displacement of the rod 20. This may be varied by varying the angles of the cam surfaces 50, 52, 54, 56. For example, the button 26 might travel 3 mm laterally and the rod 20 may be displaced 8 mm. While the button 26 and both portions 46, 48 of the actuator 36 are shown as separate components each capable of some movement relative to the others, the button 26 could be fixed to the first portion 46, and perhaps the direction of actuation of the button may be in-line or generally aligned with the path of movement of the first portion to facilitate operation of the button with this arrangement. In addition to or instead, the first and second portions 46, 48 may be connected together. Such an arrangement may require clearance between the combined actuator portions, for example, for the second portion to move toward and away from the base wall 76 (or other adjacent structure) as some vertical movement is caused by actuation of the release button 26. While in the illustrated examples the rod 20 is pushed along its centerline/axis 30 by the second portion 48 of the actuator 36, the rod could instead be pulled along the axis.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A shift lever assembly, comprising:
a shift lever having a shaft, a retainer and a button, the button being movable from a first position to a second position, and the retainer being movable relative to the shaft;
an actuator having a first portion engageable with the button as the button moves from its first position to its second position and a second portion engageable with the retainer to displace the retainer.

2. The assembly of claim 1 wherein the first portion of the actuator is a separate component from the second portion of the actuator.

3. The assembly of claim 1 wherein the first portion of the actuator is displaced by the button in a first direction, and the second portion of the actuator is displaced by the first portion in a second direction that is different than the first direction.

4. The assembly of claim 3 wherein the retainer is displaced by the second portion in a direction that is different than the direction of movement of the second portion.

5. The assembly of claim 4 wherein the first portion includes a driving surface and the second portion includes a cam surface, and the cam surface is inclined relative to the path of movement of the first portion.

6. The assembly of claim 3 wherein the first portion includes a cam surface engageable by the button when the button moves from the first position to the second position.

7. The assembly of claim 1 which also includes a biasing member that provides a force on the retainer that opposes displacement of the retainer by the actuator.

8. The assembly of claim 1 which also includes a biasing member that provides a force on the actuator that opposes displacement of the actuator by the button.

9. The assembly of claim 7 which also includes a biasing member that provides a force on the actuator that opposes displacement of the actuator by the button.

10. The assembly of claim 1 wherein the shift lever includes a knob coupled to the shaft, the button and actuator are carried by the knob and the knob includes a structure having a portion located along a line between the button and the retainer preventing direct, linear actuation of the retainer by the button.

11. The assembly of claim 10 wherein the structure defines at least part of an opening through the knob or at least part of a cavity within the knob.

12. The assembly of claim 10 wherein the knob includes a wall that at least partially defines a passage into which at least a portion of the first portion is received during movement.

13. A shift lever assembly, comprising:
a shift lever having a shaft, a knob, a retainer and a button, the knob being coupled to the shaft, the button being carried by the knob and movable from a first position to a second position, and the retainer being movable relative to the shaft;
a multi-part actuator having a first portion and a second portion, the first portion being engageable with the button as the button moves from its first position to its second position to move the first portion along a first path, and the second portion being movable in response to movement of the first portion along a second path that is not parallel to the first path, and the second portion being engageable with the retainer to displace the retainer.

14. The assembly of claim 13 wherein the first portion engages and displaces the second portion.

15. The assembly of claim 14 wherein the first portion includes a driving surface and the second portion includes a cam surface engaged by the driving surface as the first portion moves along the first path toward the second portion, and the cam surface is inclined relative to the first path.

16. The assembly of claim 13 which also includes a biasing member that provides a force on the retainer that opposes displacement of the retainer by the second portion.

17. The assembly of claim 13 which also includes a biasing member that provides a force on the second portion that opposes displacement of the first portion and the second portion by the button.

18. The assembly of claim 13 wherein the knob includes a structure having a portion located along a line between the button and the retainer preventing direct, linear actuation of the retainer by the button.

19. The assembly of claim 18 wherein the structure defines an opening through the knob or a cavity within the knob.

20. The assembly of claim 13 wherein the knob includes a wall that at least partially defines a passage into which at least a portion of the first portion is received during movement.
